(19) United States
(12) Patent Application Publication
(10) Pub. No.: US 2024/0365974 A1
(43) Pub. Date: Nov. 7, 2024

(54) BRACKET FOR ATTACHING A SUPPORT MEMBER TO A FRAME MEMBER, ASSEMBLY INCLUDING THE SUPPORT MEMBER AND THE BRACKET

(71) Applicant: DAMOTECH INC., Boisbriand (CA)

(72) Inventors: Julien BILODEAU, Boisbriand (CA); Charles CARBONNEAU, Boisbriand (CA); François DAUDELIN, Boisbriand (CA)

(21) Appl. No.: 18/654,583

(22) Filed: May 3, 2024

Related U.S. Application Data
(60) Provisional application No. 63/463,716, filed on May 3, 2023.

(51) Int. Cl. A47B 47/02; F16B 7/18

(52) U.S. Cl. CPC A47B 47/028; F16B 7/187

(57) ABSTRACT

A bracket for connecting a support member to a frame member, the bracket comprising: a first side detachably attachable to the support member, and a second side comprising first and second clamping members configured to move towards and away from each other, wherein the first clamping member is rotatable about a bracket axis and has an elongate configuration. An assembly comprising the bracket and the support member. A rack comprising at least two of the frame members and the assembly.

### CROSS-REFERENCE

The present application claims priority to U.S. Provisional Patent Application No. 63/463,716, filed May 3, 2023, entitled “BRACKET FOR ATTACHING A SUPPORT MEMBER TO A FRAME MEMBER, ASSEMBLY INCLUDING THE SUPPORT MEMBER AND THE BRACKET”, which is incorporated by reference herein in its entirety.

### FIELD OF THE DISCLOSURE

The present application relates to brackets for attaching a support member to a frame, and an assembly including the bracket and the support member.

### BACKGROUND OF THE DISCLOSURE

Frames and rack systems such as those used in the pallet rack industry comprise multiple frame members supporting shelves.

Over time they may need repair for various reasons such as over-loading, contact damage from forklift trucks, etc.

Current solutions for repairing such racks or the damaged frame members comprise support members that can be attached diagonally or horizontally between two adjacent frame members. However, current brackets for attachment of the existing support members to the frame members can interfere with shelf placement.

Therefore, there is a need for a bracket that overcomes or reduces at least some of the above-described problems.

### SUMMARY OF THE DISCLOSURE

Certain aspects and embodiments of the present technology overcome or reduce at least some of the problems of known brackets for attaching support members to frame members.

Broadly, brackets of the present technology, can attach to a frame member as well as a support member by engaging with a wall of the frame member only on one side of the frame member, thereby leaving other sides of the frame member available for attachment of shelves and other attachments. More specifically, the bracket is for use with frame members having a channel formed therein with a channel mouth, and is configured to clamp over the channel mouth from an inside and an outside of the channel.

Broadly, according to certain aspects and embodiments of the present technology, there is provided an assembly for connecting a support member to a frame member having walls defining a channel therein, the channel having a channel mouth, the assembly comprising: the support member; a bracket comprising: a first side detachably attachable to the support member, and a second side comprising first and second clamping members configured to clamp one on either side of the channel wall, wherein the first clamping member is configured to be modulated between a first configuration in which it can pass through the channel mouth and a second configuration in which it cannot pass through the channel mouth.

In certain embodiments, a width of the channel narrows at the channel mouth.

In certain embodiments, the first clamping member is rotatable about a bracket axis for modulating between the first and second configurations.

In certain embodiments, the first clamping member can be modulated between the first and second configurations by rotating the first clamping member about 90 degrees.

In certain embodiments, the first clamping member is elongate with a width which is narrower than the channel mouth and a length which is broader than the channel mouth, and wherein in the first configuration a longitudinal axis of the first clamping member is oriented parallel to a longitudinal axis of the channel and in the second configuration the longitudinal axis is transverse to the longitudinal axis of the channel.

In certain embodiments, the first and second clamping members are movable relative to each other by a threaded engagement.

In certain embodiments, the second clamping member is sized and shaped to cover the channel mouth of the frame member.

In certain embodiments, the first and second clamping members have respective inner faces that face one another.

In certain embodiments, the inner faces are flat.

In certain embodiments, the inner face of the first clamping member has at least one protrusion extending towards the second clamping member.

In certain embodiments, the assembly further comprises at least one protrusion on one of the bracket and the frame, and at least one opening on the other of the bracket and the frame, the at least one pin and the at least one opening being inter-engageable.

In certain embodiments, the at least one pin extends from the second clamping member towards the first clamping member.

In certain embodiments, at the first side of the bracket, a pair of wings extend from a body portion of the bracket, the pair of wings being spaced apart and sized to receive an end portion of the support member therebetween.

In certain embodiments, the assembly further comprises a pivot connector for connecting the end portion of the support member to the pair of wings.

In certain embodiments, the support member comprises telescoping elongate portions.

In certain embodiments, the assembly further comprises a locking mechanism to lock a relative position of the telescoping elongate portions.

In certain embodiments, the assembly further comprises another bracket detachably attachable to another end of the support member.

From another aspect, there is provided a frame comprising: first and second frame members, the first and second frame members being upright, each one of the first and second frame member having walls defining a channel therein, the channel having a channel mouth and the channel mouths of the first and second frame members facing each other; and a support member connected to the first and second frame members by first and second brackets; the first bracket having a first side attached to an end portion of a support member, and a second side comprising first and second clamping members clamped one on either side of the channel mouth of the first frame member, wherein the first clamping member is housed in the channel and has a longitudinal axis which is transverse to a longitudinal axis of the channel of the first frame member; and the second bracket having a first side attached to another end portion of the support member, and a second side comprising first and second clamping members clamped one on either side of the channel mouth of the second frame member, wherein the first clamping member is housed in the channel and has a longitudinal axis which is transverse to a longitudinal axis of the channel of the second frame member.

In certain embodiments, the support member connected to the first and second frame members has a longitudinal axis which is substantially transverse to the first and second frame members.

In certain embodiments, the support member connected to the first and second frame members has a longitudinal axis which extends diagonally between the first and second frame members.

From another aspect, there is provided a bracket for connecting a support member to a frame member, the bracket comprising: a first side detachably attachable to the support member, and a second side comprising first and second clamping members configured to move towards and away from each other, wherein the first clamping member is rotatable about a bracket axis and has an elongate configuration.

From yet another aspect, there is provided a rack comprising at least two of the frame members and the assembly.

From a further aspect, there is provided a guide tool comprising: a tool body having a front side and a rear side; at least one opening defined in the tool body; a rear clamping member at the rear side configured to clamp against a wall of a frame member, a clamping mechanism, operatively connected to the rear clamping member, for modulating a distance of the rear clamping member towards and away from the tool body; and a rotation mechanism, operatively connected to the rear clamping member, for rotating the rear clamping member about a rotation axis.

In certain embodiments, the rotation mechanism comprises a shaft connected to the rear clamping member and extending from the rear side to the front side through a slot in the tool body.

In certain embodiments, the guide tool further comprises at least one drill bushing connectable to the tool body at the at least one opening.

In certain embodiments, the guide tool further comprises at least one positioning member connected to the tool body, and have a leading edge which is triangular, with a point of the triangle extending away from the rear side of the tool body.

### Definitions

The use of “including”, “comprising”, or “having”, “containing”, “involving” and variations thereof herein, is meant to encompass the items listed thereafter as well as, optionally, additional items. In the following description, the same numerical references refer to similar elements.

It must be noted that, as used in this specification and the appended claims, the singular form “a”, “an” and “the” include plural referents unless the context clearly dictates otherwise.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first channel” and “third channel” is not intended to imply any particular order, type, chronology, hierarchy or ranking (for example) of/between the channels, nor is their use (by itself) intended to imply that any “second channel” must necessarily exist in any given situation.

### BRIEF DESCRIPTION OF DRAWINGS

Further aspects and advantages of the present invention will become better understood with reference to the description in association with the following in which:

FIG. 1A illustrates an assembly connected to frame members in a horizontal configuration, according to embodiments of the present technology.

FIG. 1B illustrates the assembly of FIG. 1A connected to frame members in a diagonal configuration, according to embodiments of the present technology.

FIG. 2A illustrates a portion of one of the frame members of FIG. 1A or 1B when viewed from an inner side of the frame member, according to embodiments of the present technology.

FIG. 2B illustrates a cross-section through a line AA′ of the portion of one of the frame members of FIG. 2A, according to embodiments of the present technology.

FIG. 3 illustrates various embodiments of the frame members having different cross-sectional profiles, according to embodiments of the present technology.

FIG. 4 is a perspective view of the assembly of FIG. 1A, the assembly comprising brackets and a support member, according to embodiments of the present technology.

FIG. 5 is a side view of the assembly of FIG. 1A, according to embodiments of the present technology.

FIG. 6 is a perspective view of the assembly of FIG. 1B, the assembly comprising brackets and a support member, according to embodiments of the present technology.

FIG. 7 is a top view of the bracket of the assembly of FIG. 1A or 1B when a first clamping member of the bracket is in a second configuration, according to embodiments of the present technology.

FIG. 8 is a perspective view, from a second side, of the bracket of FIG. 7, according to embodiments of the present technology.

FIG. 9 is a side view of the bracket of FIG. 7, according to embodiments of the present technology.

FIG. 10 is an exploded view of the bracket of FIG. 7, according to embodiments of the present technology.

FIG. 11 is a perspective view, from the second side, when the first clamping member of the bracket is in a first configuration, according to embodiments of the present technology.

FIG. 12 is a perspective view of another alternative of a bracket for an assembly, according to embodiments of the present technology.

FIG. 13 is a right perspective side view of a tool for preparing a frame member before connecting the bracket of FIG. 7 thereto, according to embodiments of the present technology.

FIG. 14 is a rear view of the tool of FIG. 13, according to embodiments of the present technology.

FIG. 15 is a front perspective view of the tool of FIG. 13, according to embodiments of the present technology.

FIG. 16 is a left perspective side view of the tool of FIG. 13, according to embodiments of the present technology.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

There is provided a support assembly 10 configured to be attached to, and extend between, frame members 100, such as of a rack system (not shown). The support assembly 10 may be used to provide reinforcement to the frame members 100 or to the rack system. The support assembly 10 may be retro-fit to an existing rack system needing reinforcement.

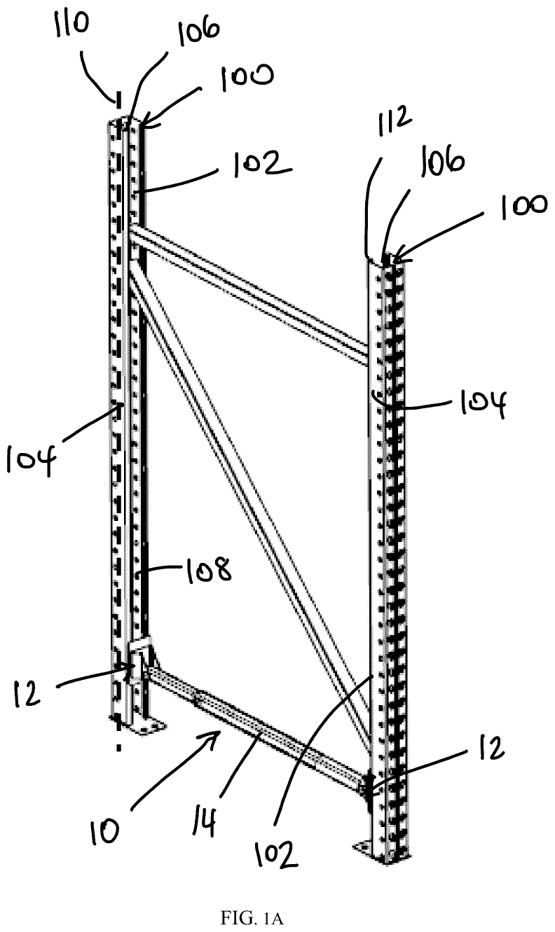

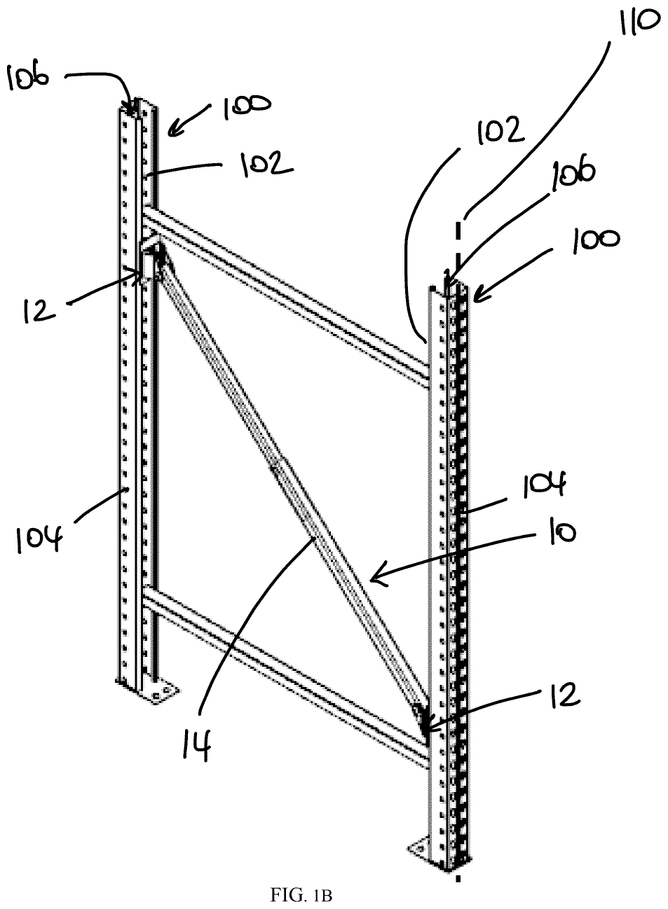

In this respect, and referring to FIGS. 1A and 1B, there are shown embodiments of the support assembly 10 connected to two frame members 100. Although only two frame members 100 are illustrated in FIGS. 1A and 1B, the current technology is not limited to two frame members 100 and may include less or more. For example, the frame members 100 may be part of a larger rack system having four or more frame members 100. The frame members 100 are upright, and the rack system may include other types of frame members 100 not necessarily upright, as well as shelves (not shown). In one example, the rack system comprises four frame members supporting shelves. The support assembly 10 may be connected to the frame members 100 in a horizontal (FIG. 1A) or a diagonal (FIG. 1B) configuration. In use the support assembly 10 is attached to, and extends between the frame members 100. As will be described below, the support assembly 10 is configured to attach to the frame members 100 at an inner side 102 thereof. By inner sides 102 is meant sides of adjacent frame members 100 that face each other.

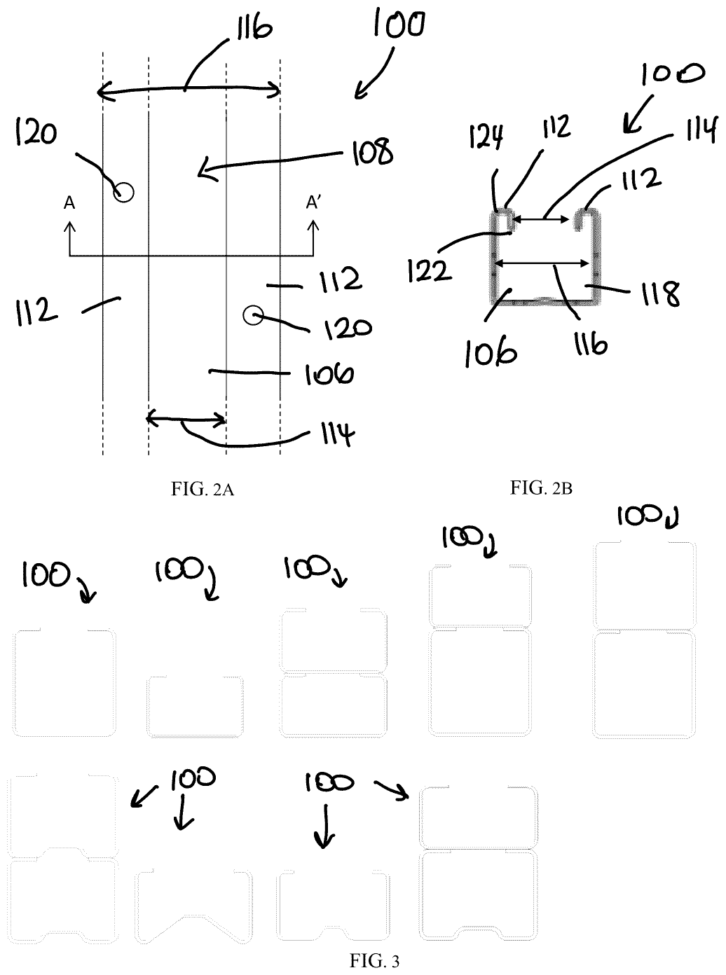

The support assembly 10 is configured to attach to frame members 100 of a lipped channel type, which will now be described with reference to FIGS. 1A, 1B, 2A, 2B and 3. The frame member has a wall or walls 104 defining a channel 106 with a channel mouth 108. The frame member 100 may be considered as having a single wall 104 which is angled relative to each other, or as having a plurality of walls 104 at angles to each other. The channel 106 has a longitudinal axis 110. The channel mouth 108 is parallel to the longitudinal axis 110. The channel mouth 108 is lipped 112 and has a width 114 at the channel mouth 108 which is less than a width 116 in a main portion 118 of the channel (FIG. 2A). The frame member 100 has a U-shaped profile when viewed in cross-section along a plane transverse to the longitudinal axis. The lips 112 of the channel mouth 108 extend inwardly towards the channel main portion 118. The configuration of the lips are not important and extension of the lips inwardly is not necessarily needed.

As seen in FIGS. 1A and 1B, the frame members 100 are mounted such that the channel mouth 108 of each frame member 100 faces each other, at the inner side 102 of the frame member 100. Without limitation, other example frame member 100 profiles with which the support assembly 10 of the present technology can be used are illustrated in FIG. 3.

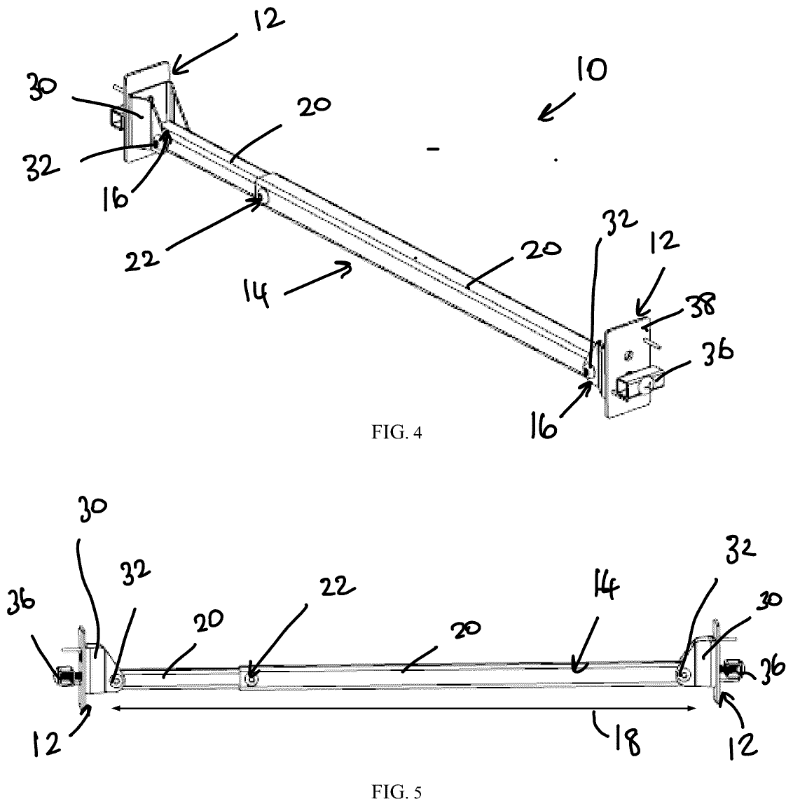

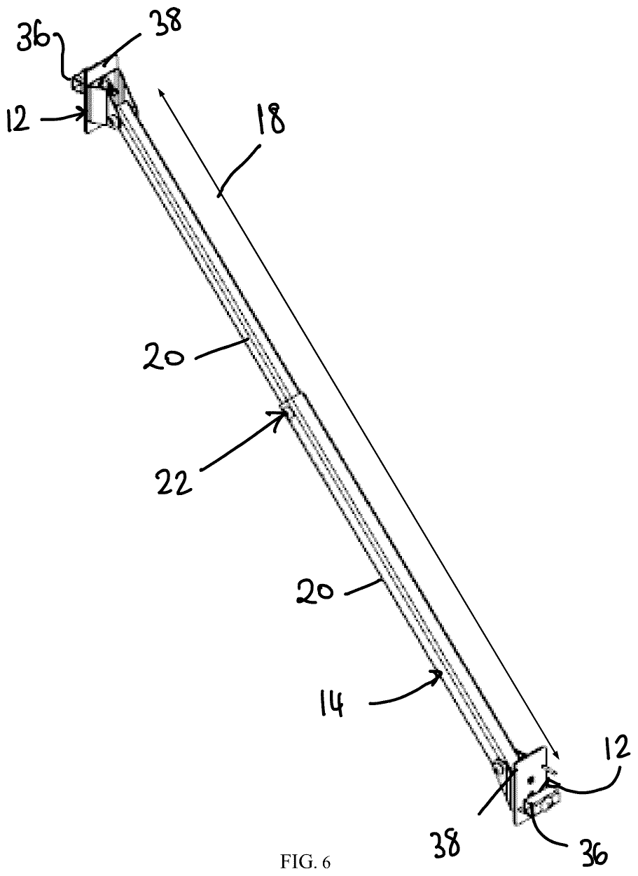

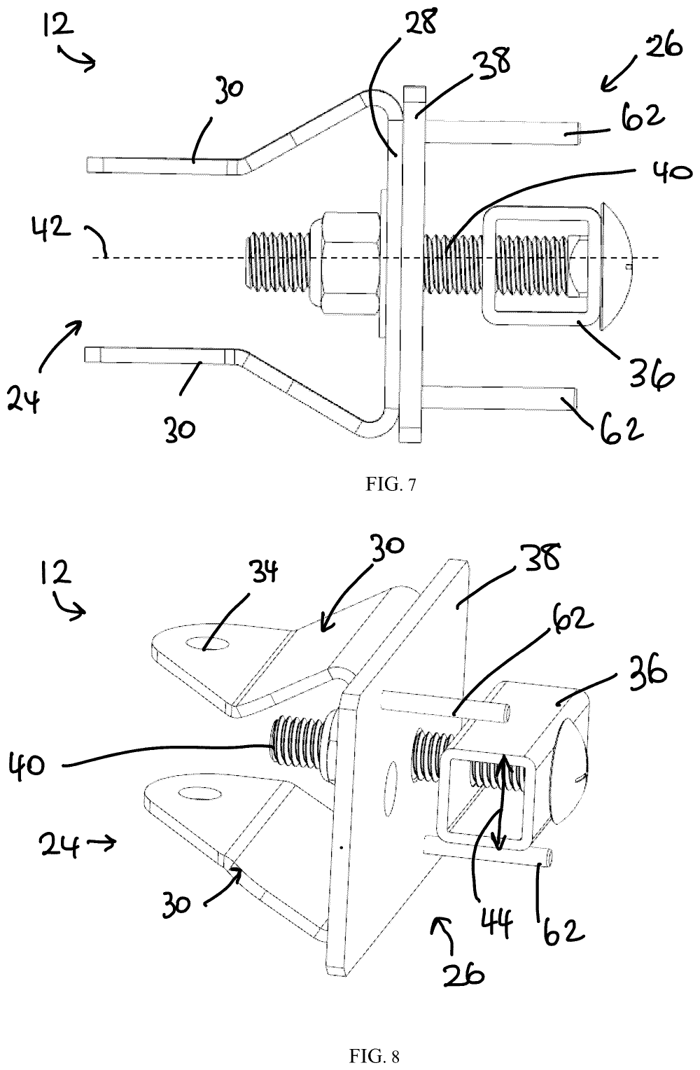

FIGS. 4 to 6 show different views of the support assembly 10 separated from the frame members 100. The support assembly 10 comprises brackets 12 and a support member 14. The brackets 12 are attachable to both the support member 14 and the frame members 100 and can be used for connecting the support member 14 to the frame members 100. The support member 14 has two ends 16 and a length 18 which is adjustable permitting the support assembly 10 to be connected to frame members 100 with different spacings therebetween. The adjustable length 18 also permits the support assembly 10 to be connected to the frame members 100 at different orientations (e.g. horizontal, diagonal, etc.), inclinations and used at any height and/or position. In this respect, it can be seen that the support assembly 10 with the diagonal configuration in FIGS. 4 and 5 has a longer length than the support assembly 10 with the horizontal configuration in FIG. 6.

More specifically, the support member 14 comprises elongate portions 20 which are telescoping. The elongate portions 20 can be moved relative to each other to modulate the length 18 of the support member 14. More than two elongate portions which telescope may be provided. A locking mechanism 22 for locking a relative position of the telescoping elongate portions 20, and hence the length 18, is provided. The locking mechanism 22 is a screw. In other embodiments, the locking mechanism 22 may comprise any other means to block relative movement of the telescoping elongate portions 20 such as a clasp, a clamp, a key, etc. In other embodiments, the support member 14 is a single piece.

The bracket 12 will now be described in more detail with reference to FIGS. 7 to 10. The bracket 12 comprises a first side 24 configured to detachably attach to the support member 14, and a second side 26 configured to detachably attach to the frame member 100.

At the first side 24 of the bracket 12, there is provided a body portion 28 and a pair of wings 30 extending from the body portion 28. The body portion 28 is plate-like. The pair of wings 30 are spaced apart from each other and sized to receive the end 16 of the support member 14 therebetween. The end 16 of the support member 14 is connected to the pair of wings 30 by a bolt 32 extending through openings 34 at a distal end of each wing 30. This construction enables a relative angle between the support member 14 and the bracket 12 to be adjusted depending on which orientation the support member 14 is to be attached to the frame members 100. Instead of the bolt 32 and openings 34, any other pivot type connection is also within the scope of the present technology. In certain embodiments, instead of the end 16 of the support member 14 being connected to the bracket 12, it may be end portions.

At the second side 26 of the bracket 12, there are provided first and second clamping members 36, 38 configured to clamp one on either side of the channel mouth 108 of the frame member 100. In this respect, the first and second clamping members 36, 38 are configured to move towards and away from each other to effect the contact with the frame member 100 around the channel mouth 108. The first and second clamping members 36, 38 are connected by a threaded member 40 which extends along a bracket axis 42 (FIG. 7). The threaded member 40 extends between the first and second sides 24, 26 of the bracket 12.

The first clamping member 36 has an elongate shape and is rotatable about the bracket axis 42. In the embodiment illustrated in the Figures, the first clamping member 36 is cuboid in shape. However, in other embodiments, the first clamping member 36 may be ellipsoid in shape. Other elongate shapes are possible. Generally, the first clamping member 36 may be any shape, such as an irregular shape, in which a widest dimension when the first clamping member 36 is in a first configuration is narrower than the width 114 of the channel mouth 108 and permits the first clamping member 36 to be inserted into the channel 106 through the channel mouth 108.

In the second configuration, a widest dimension is wider than the width 114 of the channel mouth 108 and blocks the first clamping member 36 from being removed from the channel mouth 108. The first clamping member 36 has a width 44 which is narrower than the channel mouth 108 and a length 46 which is broader than the channel mouth 108. In the first configuration a longitudinal axis 48 of the first clamping member 36 is oriented parallel to the longitudinal axis 110 of the channel 106 and in the second configuration the longitudinal axis 48 of the first clamping member 36 is transverse to the longitudinal axis 110 of the channel 106.

Rotating the first clamping member 36 modulates between the first and second configurations. More specifically, the first clamping member 36 can be modulated between the first and second configurations by rotating the first clamping member 36 about 90 degrees. In other words, the first and second configurations comprise different orientations of the first clamping member 36, the different orientations having a 90 degree difference. The extent of rotation required to modulate between the first and second configurations may be different for other shapes of the first clamping member 36. In other embodiments, the configuration of the first clamping member 36 may be modulated by any other action, such as by sliding, pushing, applying heat, cold or light to the first clamping member 36.

As best seen in FIGS. 8 and 10, the first clamping member 36 is hollow. In other embodiments, the first clamping member 36 may be solid or at least partially filled.

The second clamping member 38 is sized and shaped to cover the channel mouth 108 of the frame member 100. As best seen in FIG. 10, the second clamping member 38 is plate-like and has a width 50 and a length 52 with larger dimensions than the channel mouth 108. The second clamping member 38 is larger than the first clamping member 36 and cannot be inserted through the channel mouth 108.

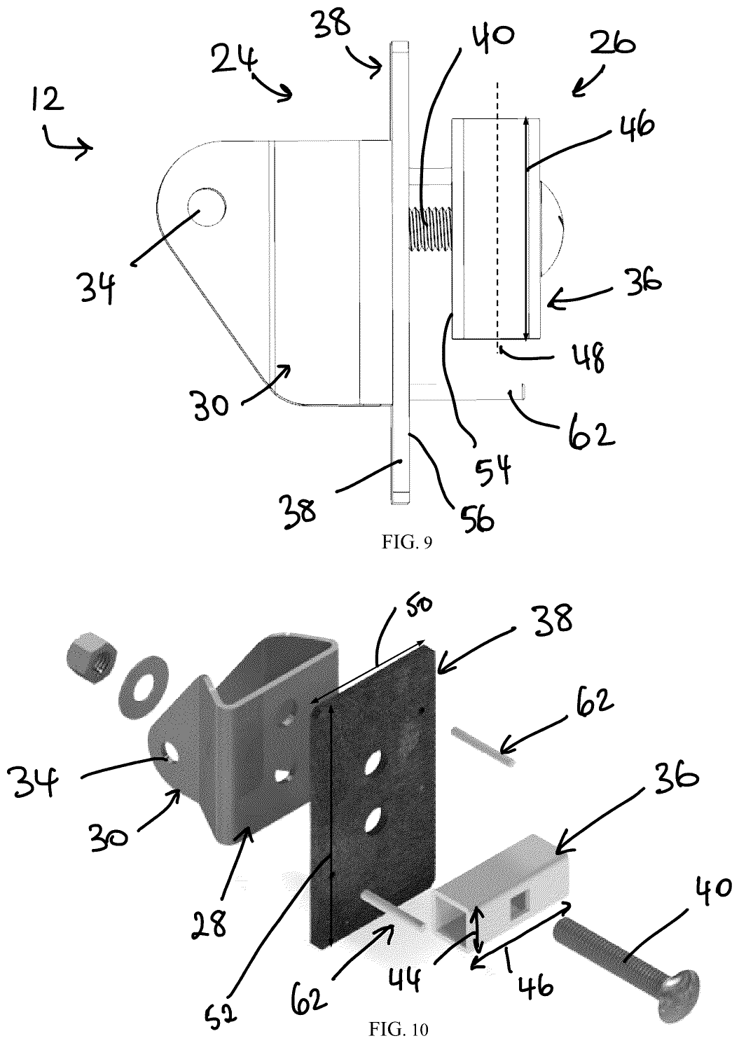

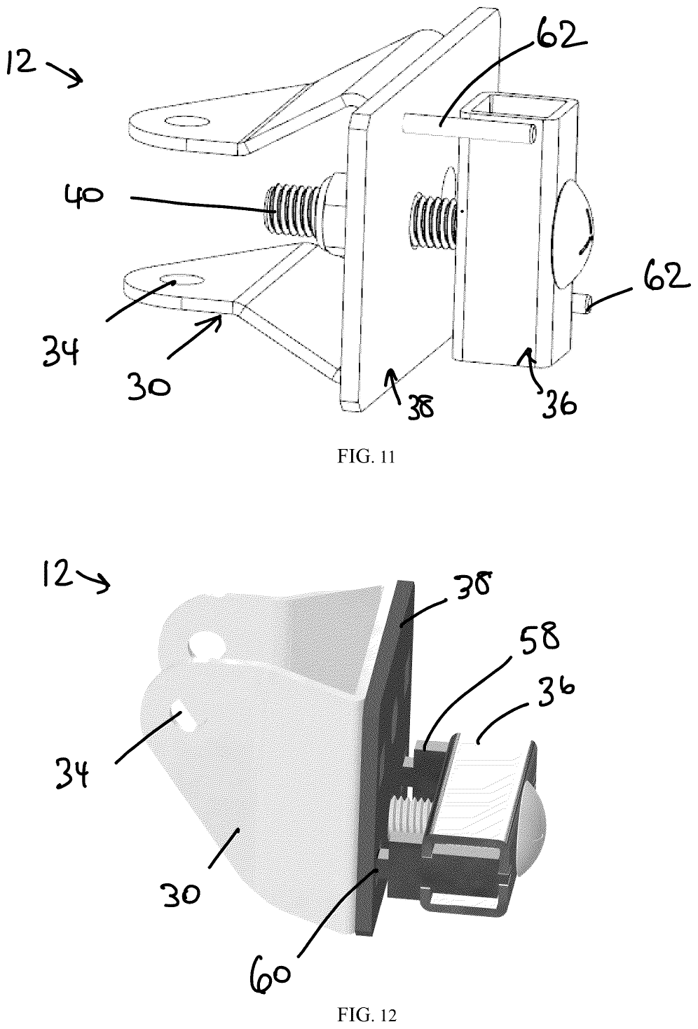

As best seen in FIG. 9, the first and second clamping members 36, 38 have respective inner faces 54, 56 that face one another. The inner faces 54, 56 are flat.

Another embodiment of the first clamping member 36 is shown in FIG. 12 in which the inner face 54 of the first clamping member 36 has two protrusions 58 extending towards the second clamping member 38. There may be more than or less than two protrusions 58. Openings 60 are provided in the second clamping member 38 for receiving ends of the two protrusions 58 when the first and the second clamping members 36, 38 are clamped about the channel mouth 108.

Referring back to the embodiment of the first clamping member 36 shown in FIGS. 7 to 10, there is further provided two protrusions 62 extending from the second clamping member 38 towards the first clamping member 36. The protrusions 62 are diametrically opposed. The protrusions 62 are sized and shaped to be received in openings 120 in the lips 112 of the channel mouth 108 of the frame member 100. In other embodiments, there may be more than, or less than, two protrusions 62. The protrusions 62 may be positioned differently than the manner shown in the Figures. In certain embodiments, the protrusions 62 extend from the frame member 100 and the openings 120 are defined in the second clamping member 38. The protrusions 62 are not provided in the embodiment of the bracket shown in FIG. 12.

To attach the bracket 12 to the frame member 100, the first clamping member 36 is placed in the first configuration such that the first clamping member 36 can be received in the channel 106 through the channel mouth 108. The first and second clamping members 36, 38 are brought closer together such that the protrusions 62 are received in the openings 120 in the lips 112 of the channel mouth 108. The first clamping member 36 is caused to rotate by 90 degrees so that the longitudinal axis 48 of the first clamping member 36 is transverse to the longitudinal axis 110 of the channel 106. The first and second clamping members 36, 38 are brought closer together until the first and second clamping members 36, 38 are sandwiched one on either side of the channel mouth 108. The first clamping member 36 contacts an inner side 122 of the channel lips 112 of the frame member 100 and the second clamping member 38 contacts an outer side 124 of the channel lips 112 of the frame member 100 when the bracket 12 and the frame member 100 are connected.

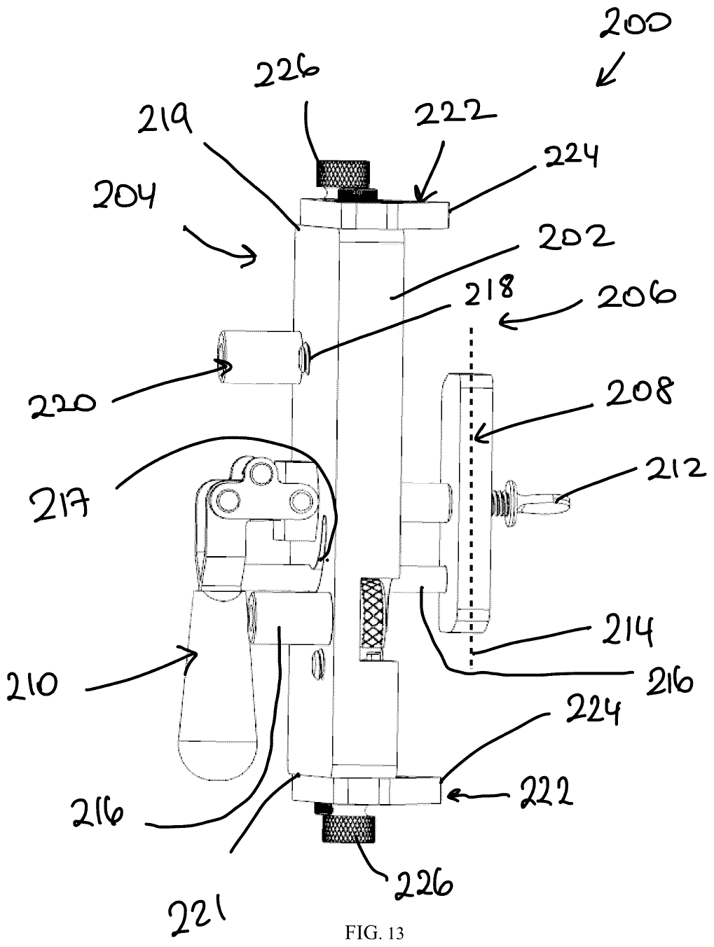

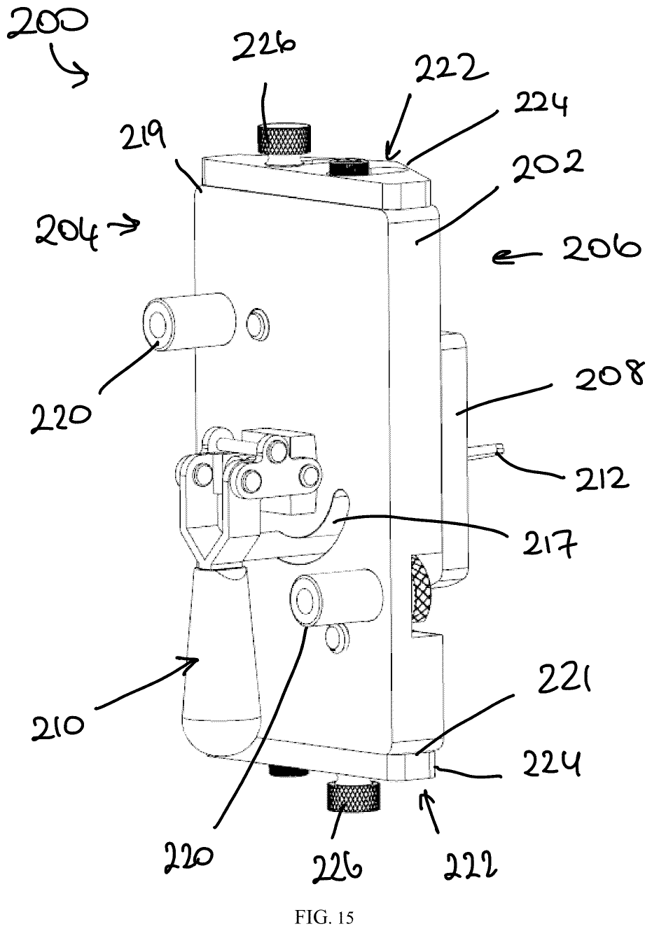

Referring now to FIGS. 13 to 16, there is also provided a guide tool 200 for assisting with the formation of the openings 120, such as by drilling, in the frame member 100 channel lips 112 for receiving the protrusions 62 extending from the second clamping member 38. The guide tool 200 ensures that the openings 120 can be formed at an appropriate distance and position relative to each other in order to receive the protrusions 62 of the bracket 12. In cases where the openings 120 are to be formed by drilling, the guide tool 200 also supports a drill bit (not shown) during the drilling. This could be helpful, such as in cases where one or more faces of the frame member 100 are uneven and could negatively impact the drilling.

The guide tool 200 comprises a tool body 202 having a front side 204 and a rear side 206. At the rear side 206 is provided a rear clamping member 208. A clamping mechanism is provided for modulating a distance of the rear clamping member 208 from the tool body 202 in a clamped position and a release position. The clamping mechanism comprises, in certain embodiments, a handle 210 at the front side 204 which is operatively connected to the rear clamping member 208, such that moving the handle causes the rear clamping member 208 to modulate between the clamped position and the release position. A spacing of the rear clamping member 208 is closer to the tool body 202 in the clamped position compared to the release position. The handle 210 comprises a push-pull toggle clamp. In other embodiments, the implementation of the clamping mechanism may be of any other type permitting the movement of the rear clamping member 208 towards and away from the tool body 202. A thumb screw 212 extends through the rear clamping member 208 and is operatively connected to the handle 210 for adjusting a distance from the tool body 202, and hence a clamping force, of the rear clamping member 208.

The tool body 202 is made of aluminium which can dissipate heat generated during the drilling process. In other embodiments, the tool body 202 may be made of any other material.

The rear clamping member 208 is elongate and has a longitudinal axis 214. The rear clamping member 208 is sized and shaped to be received in the channel 106 of the frame member 100 when the longitudinal axis 214 of the rear clamping member 208 is aligned with the longitudinal axis 110 of the channel 106.

There is provided a rotation mechanism for causing a rotation of the rear clamping member 208 about a rotation axis 209 of the rear clamping member 208. The rotation axis 209 of the rear clamping member 208 is transverse to the longitudinal axis 214 of the rear clamping member 208. When the rear clamping member 208 is rotated within the channel 106 by 90 degrees, similar to the operation of the first clamping member 36, it will rotate within the channel 106 of the frame member 100 and will be retained in the channel 106 due to the longitudinal axis 214 of the rear clamping member 210 being transverse to the longitudinal axis 110 of the frame member 100 and a contact of the rear clamping member 208 with the inner side 122 of the channel lips 112.

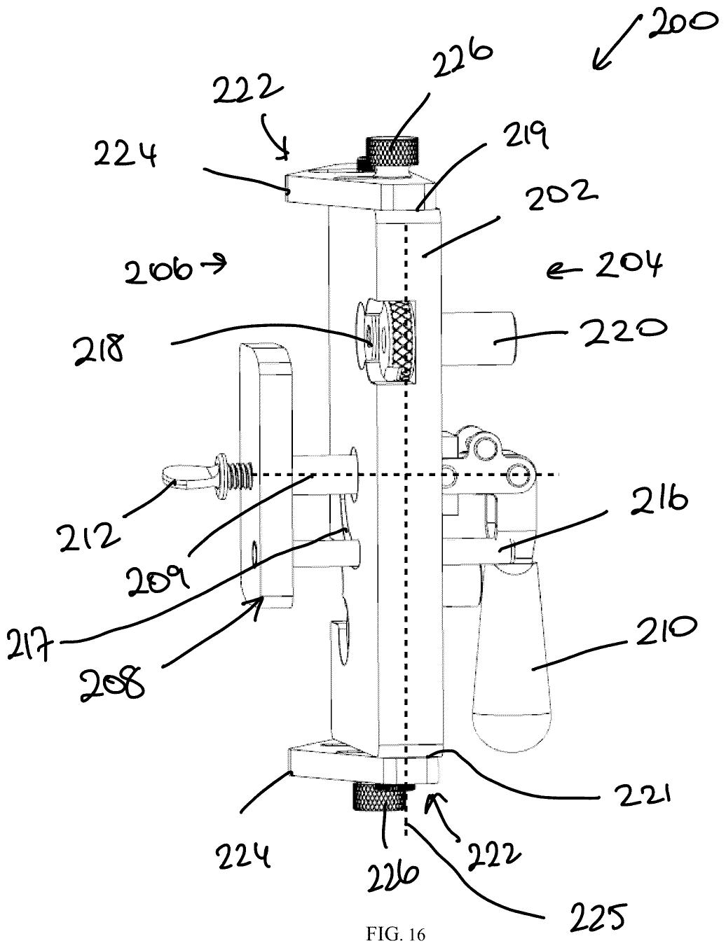

The rotation mechanism comprises a shaft 216, connected to the rear clamping member 208, and extend to the front side 204. The shaft 216 is connected to the rear clamping member 208 spaced from the rotation axis 209. The shaft 216 comprises a dowel pin, for example. As best seen in FIG. 16, the shaft 216 extends from the rear clamping member through a slot 217 in the tool body 202 to the front side 204 of the guide tool 200. The slot is shaped so as to trace the rotational movement of the shaft 210 and can function to guide the movement of the shaft 210 as the rear clamping member 208 is rotated about the rotation axis 209. In other embodiments, the shaft 210 may comprise any other element which is operatively connected to the rear clamping member 208 and configured to cause a rotation of the rear clamping member 208 about the rotation axis 209.

There are provided drill openings 218 in the tool body 202 which have a relative positioning corresponding to the relative positioning of the protrusions 62 of the bracket 12. Drill bushings 220 may be provided which are removably connected to the tool body 202 at the drill openings 218, such as by screws on any other connector. In other examples, the drill bushings 220 themselves are threaded. The drill bushings 220, when present, may be removeable so that they can be replaced when damaged or worn. Drill bushings 220 of different diameters may be provided to enable drilling using different diameter drill bits if a change of diameter of the openings 120 in the frame member 100 are desired.

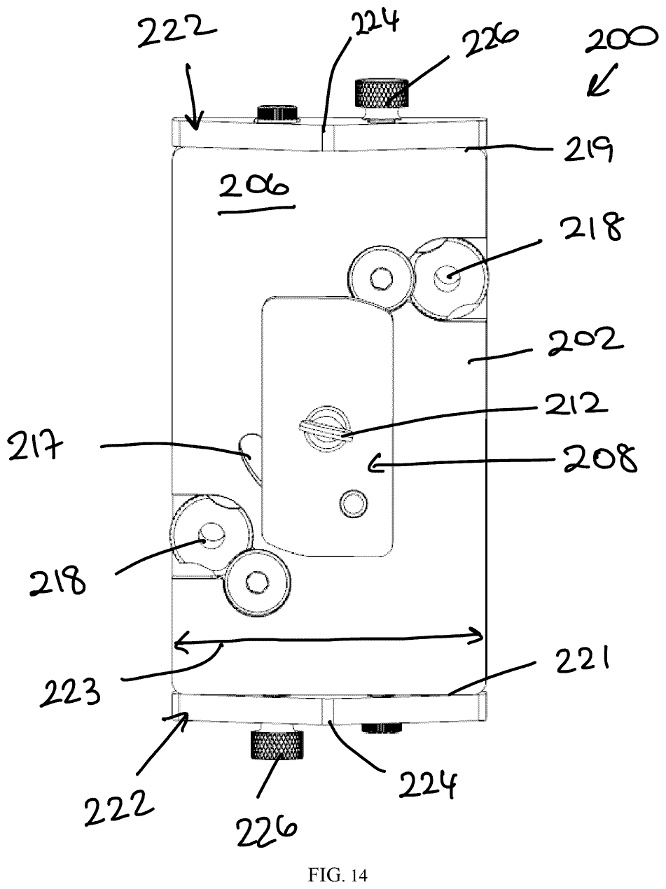

Positioning members 222 are provided on a top side 219 and a bottom side 221 of the tool body 202, and positioning centrally along a width 223 of the tool body 202 (FIG. 14). Each positioning member 222 has a triangular-shaped leading edge 224, pointing from the front side 204 towards the rear side 206 with a point of the leading edge 224 extending away from the rear side 206. When the tool body 202 is positioned against the frame member 100, the rear side 206 of the tool body 202 contacts the lips 112 of the channel 106 at the inner side 102 of the frame member 100. At least a portion of the positioning member 222 including the point is received in the channel 106 and serves to centre the tool body 202 relative to the channel 106. In certain embodiments, the positioning members 222 may be slidably connected to the tool body 202 such that the positioning members 222 can slide transversely to a longitudinal axis 225 of the tool body 202 (FIG. 16). Fasteners 226, such as screws, may be provided to lock the position of the positioning members 222 to the tool body 202. There may be provided a single positioning member 222, or more than two positioning members 222. Instead of a triangular profile, the leading edge 224 may have any other shape for positioning the tool body 202 within the channel 106.

In use, the tool body 202 of the guide tool 200 is positioned adjacent the frame member 100 with the rear side 206 of the tool body 202 over the channel 106 of the frame member 100 at the inner side 102 thereof. The rear clamping member 108 is positioned so that it is received in the channel 106, and the lateral position of the tool body 202 is adjusted using the positioning members 222. When the desired position is obtained, the rear clamping member 208 is rotated by 90 degrees, and is modulated to the clamped position. The extent of the clamping can be further adjusted using the thumb screw 212, if needed. With the tool body 202 of the guide tool 200 well positioned against the frame member 100, the openings 120 in the lips 112 of the frame member 100 can then be formed by drilling.

Although the guide tool 200 has been described for use with the support assembly 10 and the frame members 100 described herein, the guide tool 200 is also suitable for use independently of the support assembly 10 and the frame members 100.

Variations and modifications will occur to those of skill in the art after reviewing this disclosure. The disclosed features may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented. Examples of changes, substitutions, and alterations are ascertainable by one skilled in the art and could be made without departing from the scope of the information disclosed herein.

It should be appreciated that the invention is not limited to the particular embodiments described and illustrated herein but includes all modifications and variations falling within the scope of the invention as defined in the appended claims.

1. An assembly for connecting a support member to a frame member having walls defining a channel therein, the channel having a channel mouth, the assembly comprising:
the support member;
a bracket comprising:
a first side detachably attachable to the support member, and
a second side comprising first and second clamping members configured to clamp one on either side of the channel wall, wherein the first clamping member is configured to be modulated between a first configuration in which it can pass through the channel mouth and a second configuration in which it cannot pass through the channel mouth.

2. The assembly of claim 1, wherein a width of the channel narrows at the channel mouth.

3. The assembly of claim 1, wherein the first clamping member is rotatable about a bracket axis for modulating between the first and second configurations.

4. The assembly of claim 3, wherein the first clamping member can be modulated between the first and second configurations by rotating the first clamping member about 90 degrees.

5. The assembly of claim 1, wherein the first clamping member is elongate with a width which is narrower than the channel mouth and a length which is broader than the channel mouth, and wherein in the first configuration a longitudinal axis of the first clamping member is oriented parallel to a longitudinal axis of the channel and in the second configuration the longitudinal axis is transverse to the longitudinal axis of the channel.

6. The assembly of claim 1, wherein the first and second clamping members are movable relative to each other by a threaded engagement.

7. The assembly of claim 1, wherein the second clamping member is sized and shaped to cover the channel mouth of the frame member.

8. The assembly of claim 1, wherein the first and second clamping members have respective inner faces that face one another.

9. The assembly of claim 8, wherein the inner face of the first clamping member has at least one protrusion extending towards the second clamping member.

10. The assembly of claim 1, further comprising at least one protrusion on one of the bracket and the frame, and at least one opening on the other of the bracket and the frame, the at least one pin and the at least one opening being inter-engageable.

11. The assembly of claim 10, wherein the at least one pin extends from the second clamping member towards the first clamping member.

12. The assembly of claim 1, wherein at the first side of the bracket, a pair of wings extend from a body portion of the bracket, the pair of wings being spaced apart and sized to receive an end portion of the support member therebetween.

13. The assembly of claim 12, further comprising a pivot connector for connecting the end portion of the support member to the pair of wings.

14. The assembly of claim 1, wherein the support member comprises telescoping elongate portions.

15. The assembly of claim 14, further comprising a locking mechanism to lock a relative position of the telescoping elongate portions.

16. The assembly of claim 1, further comprising another bracket detachably attachable to another end of the support member.

17. A frame comprising:
first and second frame members, the first and second frame members being upright, each one of the first and second frame member having walls defining a channel therein, the channel having a channel mouth and the channel mouths of the first and second frame members facing each other; and
a support member connected to the first and second frame members by first and second brackets;
the first bracket having a first side attached to an end portion of a support member, and a second side comprising first and second clamping members clamped one on either side of the channel mouth of the first frame member, wherein the first clamping member is housed in the channel and has a longitudinal axis which is transverse to a longitudinal axis of the channel of the first frame member; and
the second bracket having a first side attached to another end portion of the support member, and a second side comprising first and second clamping members clamped one on either side of the channel mouth of the second frame member, wherein the first clamping member is housed in the channel and has a longitudinal axis which is transverse to a longitudinal axis of the channel of the second frame member.

18. The frame of claim 17, wherein the support member connected to the first and second frame members has a longitudinal axis which is substantially transverse to the first and second frame members.

19. The frame of claim 17, wherein the support member connected to the first and second frame members has a longitudinal axis which extends diagonally between the first and second frame members.

20. A bracket for connecting a support member to a frame member, the bracket comprising:
a first side detachably attachable to the support member, and
a second side comprising first and second clamping members configured to move towards and away from each other, wherein the first clamping member is rotatable about a bracket axis and has an elongate configuration.
